(19) United States
(12) Patent Application Publication
(10) Pub. No.: US 2013/0133906 A1
(43) Pub. Date: May 30, 2013

(54) TACKER

(71) Applicant: TSUNG-WEN HUANG, Chang Hua County (TW)

(72) Inventor: TSUNG-WEN HUANG, Chang Hua County (TW)

(21) Appl. No.: 13/306,999

(22) Filed: Nov. 30, 2011

(51) Int. Cl. B25C 5/11

(52) U.S. Cl. 173/18

(57) ABSTRACT

A tacker includes a first arm pivotably connected to the body by a first pin and a second arm is pivotably connected to the body by a second pin. The first end of the second arm is movable along the underside of the first arm. A shaft is connected to the second end of the second arm and between two hook plates which are detachably hooked to a resilient plate which is connected with a push plate. The first arm is pivoted downward about the first pin while the second arm is pushed by the first arm and pivoted about the second pin. The hook plates lift the resilient plate, and are then disengaged from the resilient plate to release the push plate to eject staples. The first and second arms respectively perform two different leverage actions to save the users' efforts.

### FIELD OF THE INVENTION

The present invention relates to a tacker, and more particularly, to a tacker using two-stage of leverage to have an efficient operation.

### BACKGROUND OF THE INVENTION

A conventional tacker is shown in FIGS. 6 and 7 and generally includes a first arm 41 which has its first end pivotably connected to a second arm 43 and the body 44 of the tacker by a pin 42, and a pressing portion 411 is formed on the second end of the first arm 41. The second arm 43 has a stop pin 431 extending transversely therethrough and a guide recess 432 is defined in end of the second arm 43. A shaft 45 extends transversely through the guide recess 432 of the second arm 43 and two hook plates 46 (only one is shown) are connected on two ends of the shaft 45. Two springs 47 (only one is shown) are respectively connected to the two respective tops of the two hook plates 46. Each hook plate 46 has a hook 461 and an operation end 462, wherein the two respective hooks 461 are hooked to a resilient plate 48 which has a push plate 49 connected thereto. The body 44 has a handle portion 441 so that the user can hold the handle portion 441 to operate the tacker. When in use, the user holds the handle portion 441 and pivots the first arm 41 about the pin 42 by pushing the pressing portion 411. The second arm 43 is pushed by the first arm 41 and is pivoted about the pin 42. The shaft 45 moves along the guide recess 432 and is lifted upward so that the hook plates 46 are moved upward to compress the springs 47. Assume that the distance between the pressing portion 411 to the pin 42 is the first force arm “A” and the distance between the pin 42 to the shaft 45 is the second force arm “B”. The hooks 461 of the hook plates 46 lift the resilient plate 48 upward and the push plate 49 moves upward until the operation ends 462 of the hook plates 46 contact the stop pin 431 of the second arm 43. The hook plates 46 are pivoted upward to a position to disengage the hooks 461 from the resilient plate 48. The resilient plate 48 is then released and pushes the push plate 49 downward to eject a staple. When releasing the pressing portion 411 of the first arm 41, the spring 47 push the hook plates 46 which drives the second arm 43 downward to return the second arm 43 and the first arm 41. The hooks 461 of the hook plates 46 are then hooked to the resilient plate 48 again.

Although the length of the first force arm “A” is larger than the second force arm “B” for the conventional tacker, the users still have to apply a significant force to operate the tacker and this needs to be improved.

The present invention intends to provide an energy-saving tacker to improve the shortcomings of the conventional tacker.

### SUMMARY OF THE INVENTION

The present invention relates to a tacker and comprises a first arm having a pressing portion on the first end thereof and a connection end is formed on the second end of the first arm. The connection end is pivotably connected to the body of the tacker by a first pin and a slot is defined in the first arm. A contact part is located within the slot. A second arm has the first end thereof located in the slot and contacts the contact part of the first arm. The second end of the second arm is pivotably connected to the body by a second pin. A stop pin extends transversely through the second arm and is located below the second pin. The body has a first fixing hole, a second fixing hole, two hook plates, two springs, a resilient plate and a push plate which is connected to the resilient plate. The first pin extends through the first fixing hole of the body and the second pin extends through the second fixing hole. The second pin is located below the first pin. A shaft is connected between the two hook plates and the two springs are respectively hooked to two respective tops of the two hook plates. The two hook plates are detachably hooked to the resilient plate. The two hook plates are pivoted and contact the stop pin when the first and second arms are pivoted downward.

The primary object of the present invention is to provide an efficient tacker which comprises two leverages actions so that the users use a limited force to operate the tacker efficiently.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tacker of the present invention;

FIG. 2 is a perspective view to show the tacker of the present invention;

FIG. 3 is another perspective view to show the tacker of the present invention;

FIG. 4 is a cross sectional view of the tacker of the present invention;

FIG. 5 is a cross sectional view to show that the first and second arms are respectively pivoted downward;

FIG. 6 is a cross sectional view to show a conventional tacker, and

FIG. 7 is a cross sectional view to show that the first and second arms of the conventional tacker are pivoted downward.

### DETAILED DESCRIPTION OF THE PREFERRED EMBODIMENT

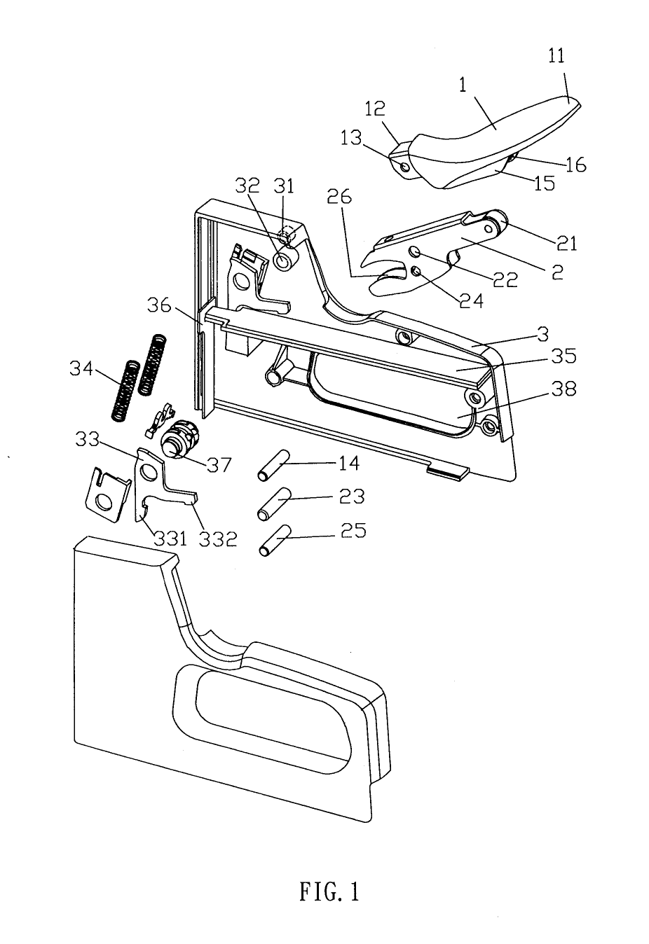

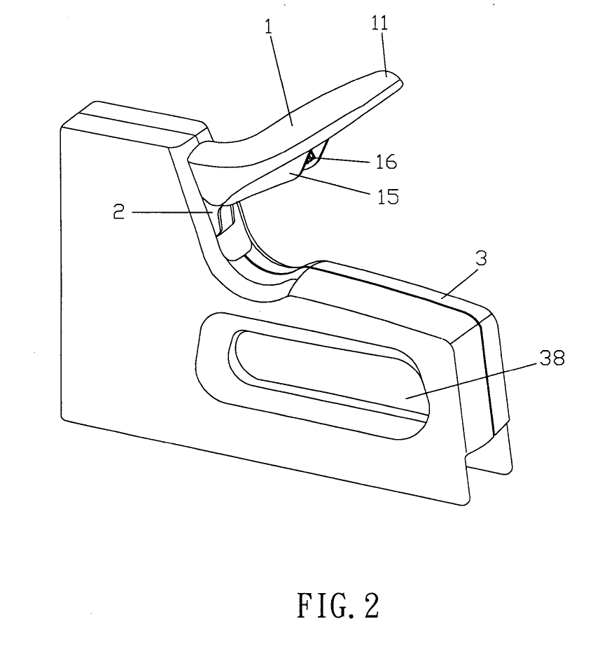

Referring to FIGS. 1 to 3, the tacker of the present invention comprises a first arm 1 having a pressing portion 11 on the first end thereof and a connection end 12 is formed on the second end of the first arm 1. A first hole 13 is defined through the connection end 12 of the first arm 1 and the connection end 12 is pivotably connected to the body 3 of the tacker by extending a first pin 14 extending through the first hole 13 and a first fixing hole 31 of the body 3. A slot 15 is defined in the underside of the first arm 1 and a contact part 16 is located within the slot 15.

A second arm 2 has roller 21 connected to the first end thereof and the roller 21 located is movable in the slot 15 and contacts the contact part 16 of the first arm 1. The second arm 2 has a second hole 22 defined through the second end thereof and a second pin 23 extends through the second hole 22. The second arm 2 further has a connection hole 24 and a stop pin 25 is securely and transversely connected to the connection hole 24 of the second arm 2 and located below the second pin 23. The second end of the second arm 2 is pivotably connected to the first arm 1 and the body 3 by extending the second pin 23 through a second fixing hole 32 in the body 3. The second pin 23 is located below the first pin 14. The second arm 2 has two extensions extending from the second end thereof and a guide recess 26 is defined between the two extensions.

Two hook plates 33, two springs 34, a resilient plate 35 and a push plate 36 are received in the body 3 and the push plate 36 is connected to the resilient plate 35 so as to eject the staples which are not shown. A shaft 37 is connected between the two hook plates 33 and movably extending through the guide recess 26. The two springs 34 are respectively hooked to two respective tops of the two hook plates 33, the other end of each of the two springs 34 are fixed to the body 3. The two hook plates 33 each have a hook 331 which is located at the first end thereof and detachably hooked to the resilient plate 35. The hook plates 33 each also have an operation end 332 which extends laterally from each of the hook plates 33.

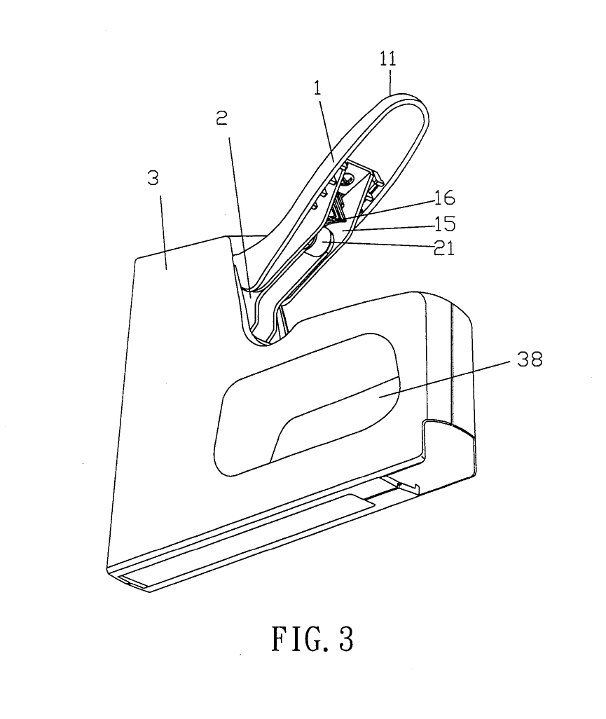

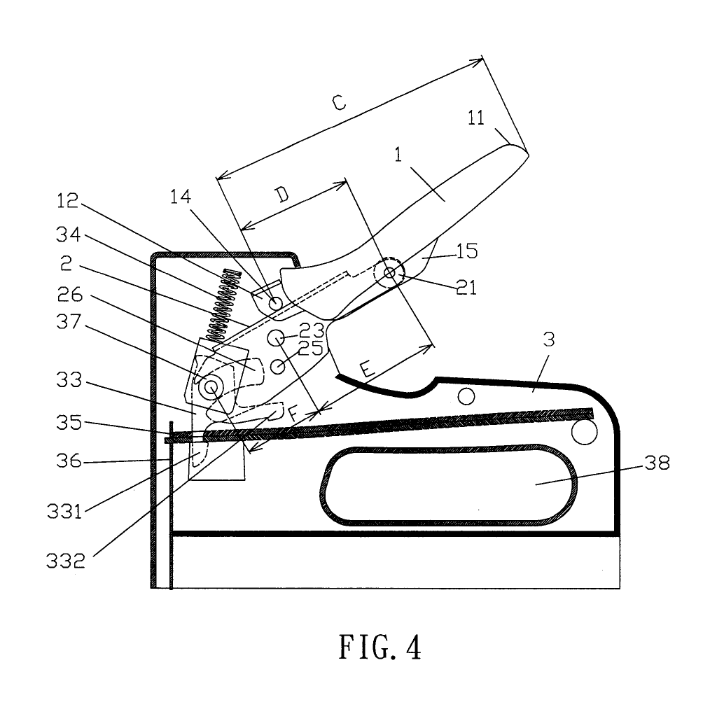

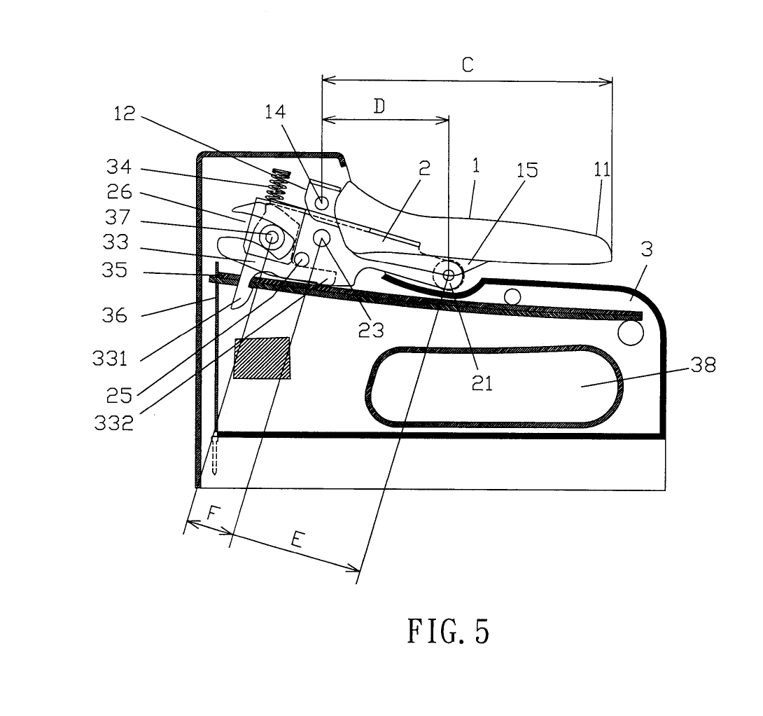

Referring to FIGS. 3 to 5, when in use, the user holds the handle portion 38 of the body 3 and pushes the pressing portion 11 of the first arm 1 so that the first arm 1 is pivoted downward about the first pin 14. Assume that the distance between the pressing portion 11 to the first pin 14 is the first force arm “C”. The contact part 16 of the first arm 1 pushes the roller 21 to move in the slot 15 so that the second arm 2 is pivoted downward about the second pin 23. Assume that the distance from the roller 21 to the first pin 14 is the second force arm “D”, and the distance from the roller 21 to the second pin 23 is the third force arm “E”. The second end of the second arm 2 is pivoted upward about the second pin 23 while the shaft 37 is moved in the guide recess 26 of the second arm 2. Assume that the distance from the second pin 23 to the shaft 37 is the fourth force arm “F”.

The upward movement of the second end of the second arm 2 lifts the shaft 37 and the two hook plates 33 upward, so that the resilient plate 35 hooked by the hooks 331 of the hook plates 33 is lifted and curved as shown. It is noted that the distance from the second pin 23 to the shaft 37, which is the fourth force arm “F” is shortened when the shaft 37 moves in the guide recess 26. When the operation ends 332 of the two hook plates 33 are in contact with the stop pin 25 of the second arm 2, the hook plates 33 are pivoted about the shaft 37 so that the hooks 331 of the hook plates 33 are disengaged from the resilient plate 35. The push plate 36 is then released and moves downward to eject the staples. When the first arm 1 is released, the springs 34 push the hook plates 33 and the second arm 2 downward, so that the first and second arms 1, 2 return their original positions, and the hooks 331 of the hook plates 33 are hooked to the resilient plate 35 again.

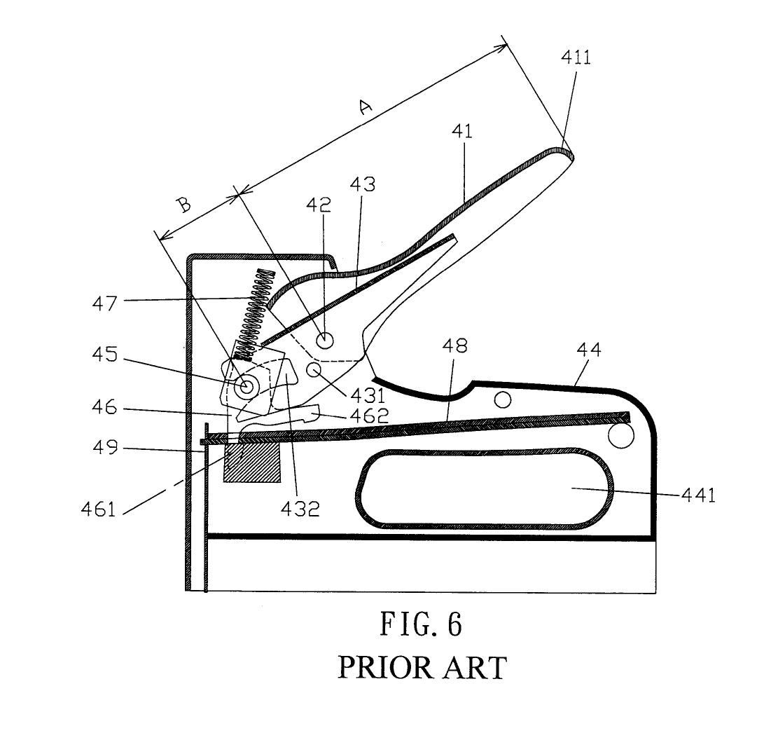

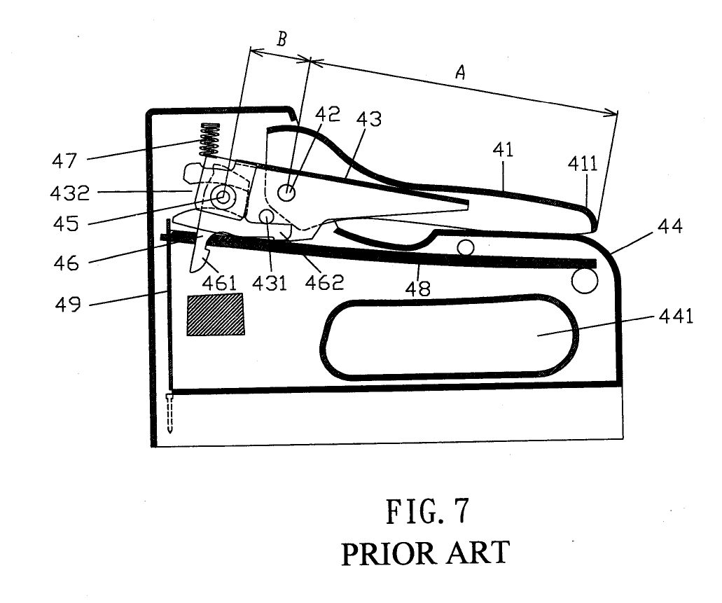

It is noted that the first force arm “C” is longer than that of the second force arm “D”, so that the first-stage efficient factor “Y” can be obtained by C/D. In addition, the third force arm “E” is longer than that of the fourth force arm “F”, so that the second-stage efficient factor “Z” can be obtained by E/F. Therefore, the tacker of the present invention has the value of YZ times of the force that applied to the pressing portion 11 to be performed to the push plate 36. For the conventional tacker as shown in FIGS. 6 and 7, the force that the push plate can perform is the value of X which is obtain by A/B as shown in FIGS. 6 and 7. The tacker of the present invention will save more than 30% of force needed to be applied to the first arm 1 when compared with the conventional tacker as shown in FIGS. 6 and 7.

The present invention uses two leverage actions to obtain a much larger force output from the push plate 36 so that the users can easily pivot the first arm 1 to staple objects.

While we have shown and described the embodiment in accordance with the present invention, it should be clear to those skilled in the art that further embodiments may be made without departing from the scope of the present invention.

What is claimed is:

1. A tacker comprising:
a first arm having a pressing portion on a first end thereof and a connection end formed on a second end of the first arm, a first pin extending transversely through the connection end, a slot defined in the first arm and a contact part located within the slot;
a second arm having a first end thereof located in the slot and contacting the contact part of the first arm, a second end of the second arm pivotably connected to the body and the first arm by a second pin extending transversely through the second arm, the first arm and the body, a stop pin extending transversely through the second arm and located below the second pin, and
a body having a first fixing hole, a second fixing hole, two hook plates, two springs, a resilient plate and a push plate which is connected to the resilient plate, the first pin extending through the first fixing hole of the body and the second pin extending through the second fixing hole, the second pin is located below the first pin, a shaft connected between the two hook plates and the two springs respectively hooked to two respective tops of the two hook plates, the two hook plates detachably hooked to the resilient plate, the two hook plates being pivoted and contacting the stop pin when the first and second arms are pivoted downward.

2. The tacker as claimed in claim 1, wherein the first arm 1 has a first hole defined through the connection end of the first arm and the first pin extends through the first hole.

3. The tacker as claimed in claim 1, wherein the second arm has a second hole defined through a second end thereof and the second pin extends through the second hole.

4. The tacker as claimed in claim 1, wherein the second arm has a connection hole and the stop pin is securely connected to the connection hole.

5. The tacker as claimed in claim 1, wherein the hook plates each have a hook and an operation end, the hook is located at the first end of each of the hook plates and the operation end extends laterally from each of the hook plates.

6. The tacker as claimed in claim 1, wherein the second arm has a roller located at the first end thereof.

7. The tacker as claimed in claim 1, wherein the second arm has two extensions extending from a second end thereof and a guide recess is defined between the two extensions, the shaft is movably extending through the guide recess.
